(19) United States
(12) Patent Application Publication
(10) Pub. No.: US 2015/0099468 A1
(43) Pub. Date: Apr. 9, 2015

(54) ELECTRONIC DEVICE AND GARMENT

(71) Applicant: NIKON CORPORATION, Tokyo (JP)

(72) Inventors: Sho Kamide, Yokohama-shi (JP); Shunichi Izumiya, Kawasaki-shi (JP); Hirokazu Tsuchihashi, Tokyo (JP); Chihiro Tsukamoto, Tokyo (JP); Michiyo Ogawa, Tokyo (JP); Masakazu Sekiguchi, Kawasaki-shi (JP)

(73) Assignee: NIKON CORPORATION, Tokyo (JP)

(21) Appl. No.: 14/398,746

(22) PCT Filed: May 13, 2013
(86) PCT No.: PCT/JP2013/063324

§ 371 Date: Nov. 4, 2014

(30) Foreign Application Priority Data
May 29, 2012 (JP) 2012-122022

(51) Int. Cl. H04W 4/00; H04B 13/00

(52) U.S. Cl. CPC H04W 4/008; H04B 13/005
USPC 455/41.2

(57) ABSTRACT

An electronic device includes: a communication unit that is capable of performing short range communication or communication through a human body of a user; a first input unit that, when the user touches a first object provided with a first communication member, inputs information on the first object via the first communication member and the communication unit; and a second input unit that, when the user touches a second object provided with a second communication member in a state where the user is holding the first object, inputs information on the second object via the second communication member and the communication unit.

### TECHNICAL FIELD

The present invention relates to an electronic device and a garment.

### BACKGROUND ART

Conventionally, there has been proposed a system that can report easily and accurately an action history about a position to a user using human body communication (e.g. see Patent Document 1).

### PRIOR ART DOCUMENTS

### Patent Documents

Patent Document 1: Japanese Laid-open Patent Publication No. 2010-39789

### SUMMARY OF THE INVENTION

### Problems to be Solved by the Invention

The conventional system can report a user's position when the user touches an object. However, when the object is a small article (e.g. a key), for example, the system does not tell where the user put away the small article, and hence the system is not user-friendly.

The present invention has been made in view of the above problem, and aims to provide a user-friendly electronic device. Also, the present invention aims to provide a user-friendly garment.

### Means for Solving the Problems

The electronic device of the present invention includes: a communication unit that is capable of performing short range communication or communication through a human body of a user; a first input unit that, when the user touches a first object provided with a first communication member, inputs information on the first object via the first communication member and the communication unit; and a second input unit that, when the user touches a second object provided with a second communication member in a state where the user is holding the first object, inputs information on the second object via the second communication member and the communication unit.

In this case, the electronic device may include a detection unit that detects that communication with the first communication member is disconnected. Moreover, the electronic device may include a presumption unit that presumes a position of the first object, based on a detection result of the detection unit and the information which the second input unit inputs. In this case, the second communication member may be provided in a storage body capable of storing the first object, and the presumption unit may presume whether the first object is stored in the storage body.

In the electronic device of the present invention, the second object may be an object that the user puts on, and when the user puts on the second object, the second input unit may input the information via the second communication member and the communication unit. Moreover, the electronic device may include an image capturing unit capable of capturing an image of the user. In this case, the image capturing unit may capture the image of the user at a timing corresponding to touch to the first communication member by the user. Moreover, the electronic device may include a position sensor that detect position information when the image capturing unit performs image capturing.

The electronic device of the present invention may include a position sensor that detect position information when at least one of the first input unit and the second input unit inputs the information. Moreover, the electronic device may include a sound recording unit that records a sound at a timing corresponding to touch to the first communication member by the user. Moreover, the electronic device may include a reporting unit that report a position of the first object to the user.

In a case where the electronic device of the present invention includes the detection unit, the electronic device may include an information obtaining unit that obtains information when the detection unit detects that communication with the first communication member is disconnected.

The electronic device of the present invention may include a first communication unit that, when a user touches a first object provided with a first communication member, is capable of performing short range communication via the first communication member or human body communication through a human body of the user; and an information obtaining unit that obtains information when communication with the first object by the first communication unit is disconnected.

In this case, the information obtaining unit may obtain at least one of information on a time and information on a place when the communication with the first object is disconnected. Moreover, the electronic device may include a second communication unit that, when the user touches a second object provided with a second communication member, is capable of performing short range communication via the second communication member or human body communication through the human body of the user. In this case, the electronic device may include a judgment unit that, when communication with the second communication member by the second communication unit is established, judges whether communication with the first communication member by the first communication unit is established. In this case, the electronic device may include a presumption unit that presumes a position of the first object, based on a judgment result of the judgment unit.

A garment of the present invention may include a communication unit that is provided in the pocket and is capable of performing short range communication or human body communication through a human body of a user; and an output unit that outputs information on the pocket via the communication unit.

In this case, the output unit may output information indicating that a part of the human body touches the pocket. Moreover, the output unit may output information on a position of the pocket. Moreover, the communication unit may be attachable to or detachable from the pocket.

The electronic device of the present invention may include a communication unit capable of communicating with a first communication member provided on a first object, and a second communication member provided on a second object capable of storing the first object; and a judgment unit that judges whether the first object is stored in the second object, based on a communication result of the communication unit. In this case, when communication between the first communication member and the communication unit is disconnected, the judgment unit may judge that the first object is released from a hand of the user.

### Effects of the Invention

The present invention can provide a user-friendly electronic device. Also, the present invention can provide a user-friendly garment.

### BRIEF DESCRIPTION OF DRAWINGS

FIG. 1 is a diagram schematically illustrating a state of a user which uses an information processing system according to an embodiment;

FIG. 2 is a block diagram of the information processing system;

FIG. 3 is a diagram illustrating an imaging range of an imaging unit;

FIG. 4 is a flowchart illustrating a collection process of information on an existence position of a key;

FIGS. 5A to 5C are diagrams (part 1 to part 3) illustrating relationships between timing of human body communication between each module and a portable device, and the existence position of the key;

FIGS. 6A and 6B are diagrams (part 4 and part 5) illustrating relationships between timing of the human body communication between each module and the portable device, and the existence position of the key;

FIG. 7 is a diagram illustrating an example of a key position presumption table;

FIG. 8 is a flowchart illustrating a report process about the existence position of the key; and

FIGS. 9A and 9B are diagrams explaining a process of step S42 in FIG. 8 (display examples of a display).

### MODES FOR CARRYING OUT THE INVENTION

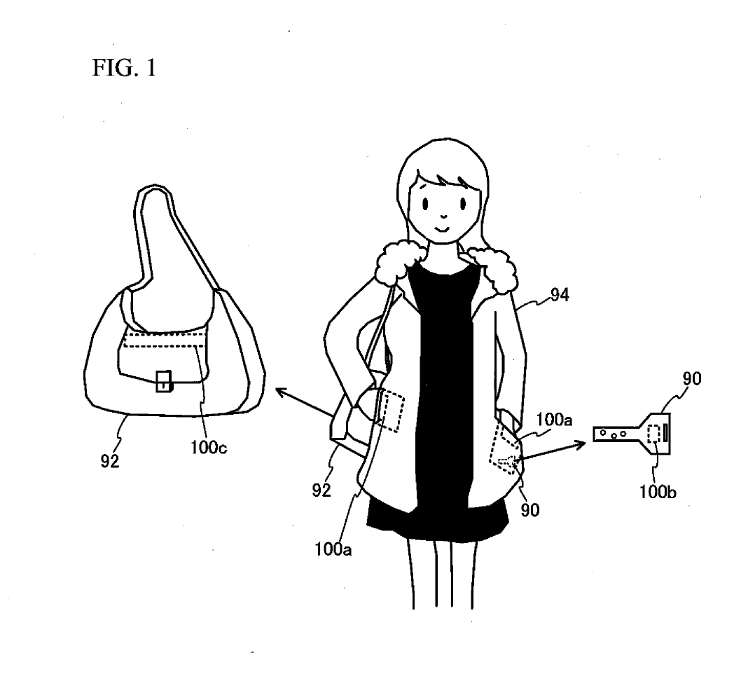

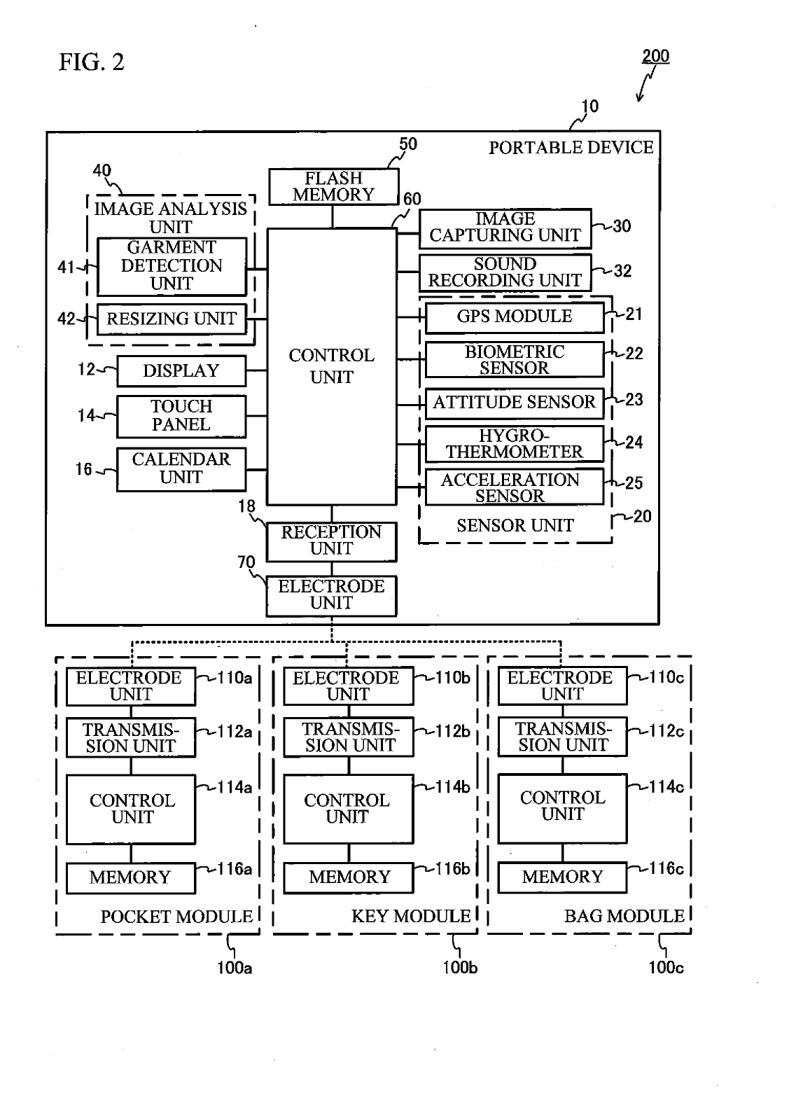

Hereinafter, a detailed description will be given of an information processing system 200 according to an embodiment, based on FIGS. 1 to 9. FIG. 1 is a diagram schematically illustrating a state of a user which uses the information processing system 200. FIG. 2 is a block diagram of the information processing system 200.

As illustrated in FIG. 2, the information processing system 200 includes a portable device 10, pocket modules 100a to which pockets (two pockets in FIG. 1) of the coat 94 of FIG. 1 are attached, a key module 100b provided on a key (e.g. a key for a door of a house), and a bag module 100c provided on an opening portion of a pocket of a bag 92 in FIG. 1.

The portable device 10 is an information device used in a state carried by a user. A mobile phone, a smart phone, a PHS (Personal Handy-phone System), a PDA (Personal Digital Assistant), and so on can be adopted as the portable device 10. In the present embodiment, it is assumed that the portable device 10 is the smart phone. The portable device 10 includes a telephone function, a communication function for connecting itself to an internet, a data processing function for executing a program, and so on.

The portable device 10 includes a display 12, a touch panel 14, a calendar unit 16, a reception unit 18, an electrode unit 70, a sensor unit 20, an image capturing unit 30, a sound recording unit 32, an image analysis unit 40, a flash memory 50, and a control unit 60, as illustrated in FIG. 2.

The display 12 displays an image, various information, and an image for operation input, such as buttons, and is a device using a liquid-crystal-display element as an example.

The touch panel 14 is an interface which can input information according to the touch of the user to the control unit 60. Since the touch panel 14 is mounted on a surface of the display 12 or incorporated in the display 12, the user can input various information intuitively by touching the surface of the display 12.

The calendar unit 16 obtains time information including a year, a month, a day and a time, and outputs the time information to the control unit 60. Here, the calendar unit 16 also has a timekeeping function.

The electrode unit 70 includes a signal electrode and a ground electrode, is electrodes for performing the human body communication with each of the modules 100a to 100c via the user. Here, not only when the user holds the portable device 10 by hand, but also when the portable device 10 is stored in a chest pocket (i.e., when a user's body is opposite to the portable device 10), the human body communication can be performed.

The reception unit 18 is composed of an electric circuit which has a band pass filter, and the reception unit 18 receives various data transmitted from the modules for communication (100a to 100c).

The sensor unit 20 includes various sensors. In the present embodiment, the sensor unit 20 includes a GPS (Global Positioning System) module 21, a biometric sensor 22, an attitude sensor 23, a hygro-thermometer 24, and an acceleration sensor 25.

The GPS module 21 is a sensor that detects a position (e.g. a longitude and a latitude) of the portable device 10.

The biometric sensor 22 is provided on a portion of the portable device 10 (the portion which is easy to touch with a user's hand), and is a sensor which obtains a condition of the user holding the portable device 10. The biometric sensor 22 obtains a body temperature, a blood pressure, a pulse, an amount of perspiration, and so on of the user, as an example. A sensor that detects the pulse by emitting light toward the user from a light emitting diode and receiving light reflected from the user depending on the emitted light, as disclosed by Japanese Laid-open Patent Publication No. 2001-276012 (i.e., U.S. Pat. No. 6,526,315), and a watch-shaped biometric sensor as disclosed by Japanese Laid-open Patent Publication No. 2007-215749 (i.e., US patent publication No. 2007/91718) can be adopted as examples of the biometric sensor 22.

Moreover, the biometric sensor 22 includes a sensor (i.e., a pressure sensor) which obtains information (e.g. a grasping power) on a power in which the user holds the portable device 10. The pressure sensor can detect that the user has held the portable device 10, and can detect a power to hold the portable device 10. Here, in a stage where the pressure sensor detects that the user has held the portable device 10, the control unit 60 as mentioned later may begin to obtain information from another biometric sensor. Moreover, in a stage where a power supply is on and the pressure sensor detects that the user has held the portable device 10, the control unit 60 may perform the control so as to turn on the other functions (or so as to return from a sleep state).

The attitude sensor 23 is provided inside the portable device 10, and detect the attitude of the image capturing unit 30 mentioned later by detecting the portable device 10. The composition which combines two or more sensors each of which detects a uniaxial attitude by whether a small sphere which moves by a gravity intercepts an infrared light of a photo-interrupter can be adopted as the attitude sensor 23. However, the attitude sensor 23 is not limited to this, and a triaxial acceleration sensor, a gyro sensor and the like may be adopted as the attitude sensor 23.

The hygro-thermometer 24 is an environment sensor that detects a temperature around the portable device 10. Here, a thermometer and a hygrometer may be separately provided in the portable device 10, instead of the hygro-thermometer 24. The hygro-thermometer 24 may include the function of the biometric sensor 22 that detects the body temperature of the user.

A piezoelectric element, a strain gauge and the like can be used for the acceleration sensor 25. In the present embodiment, the acceleration sensor 25 detects whether the user is standing or sitting down. A method for detecting whether the user is standing, sitting down, walking or running by using the acceleration sensor is disclosed in Japanese Patent No. 3513632 (or Japanese Laid-open Patent Publication No. 8-131425). A gyro sensor that detects an angular velocity may be used instead of the acceleration sensor 25 or in conjunction with the acceleration sensor 25.

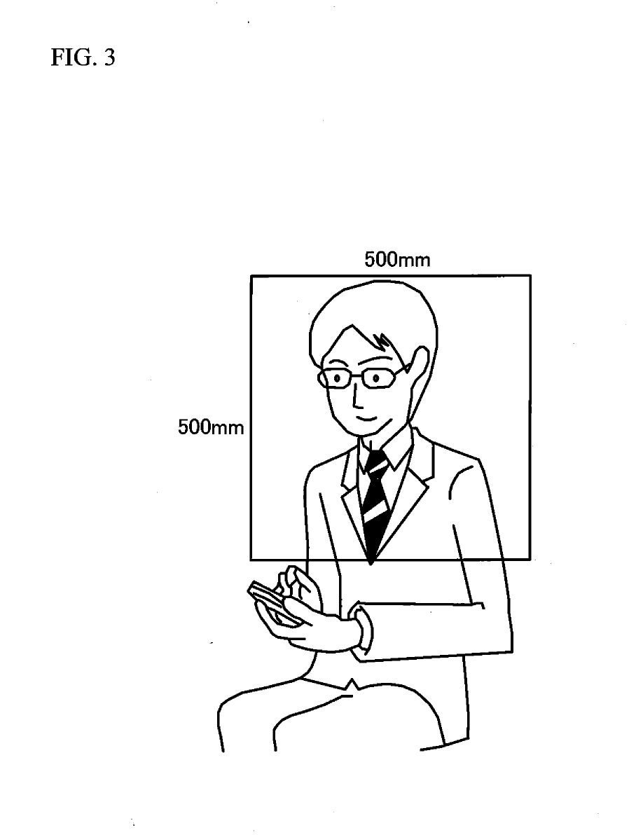

The image capturing unit 30 includes a camera, and captures an image according to an imaging instruction from the user via the touch panel or an imaging instruction from the control unit 60. In a state where the user is operating the portable device 10 as illustrated in FIG. 3, an image capturing direction and a field angle are adjusted and set so that the image capturing unit 30 can capture an image in a range between a face and a breast (i.e., the range of a 500 mm square as illustrated in FIG. 3).

The sound recording unit 32 includes a microphone, and collects and records a sound around the portable device 10 according to an instruction of the control unit 60.

The image analysis unit 40 includes a garment detection unit 41 and a resizing unit 42. The garment detection unit 41 detects a garment of the user in the image captured by the image capturing unit 30. The resizing unit 42 performs a trimming process which extracts only a garment portion from the image captured by the image capturing unit 30.

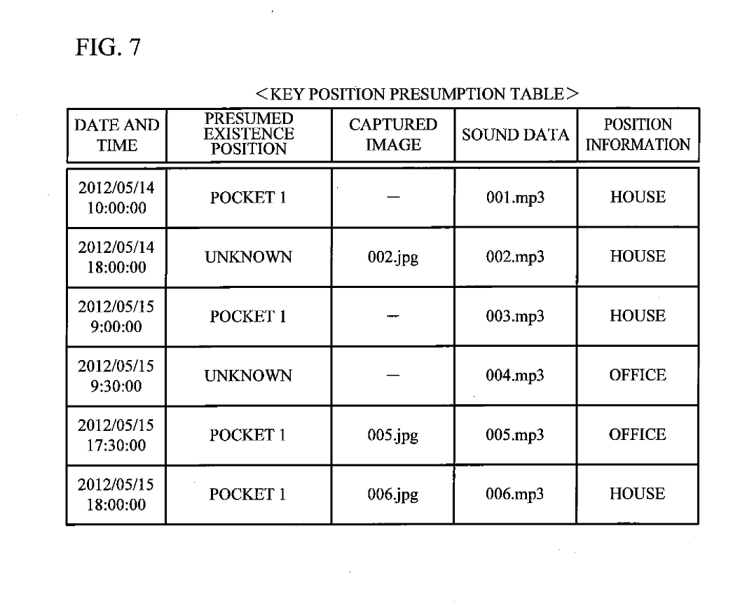

The flash memory 50 is a nonvolatile semiconductor memory. The flash memory 50 stores a program for performing control of the portable device 10 executed by the control unit 60, various parameters for controlling the portable device 10, a key position presumption table (see FIG. 7) as mentioned later, and so on.

The control unit 60 includes a CPU, and controls generally the whole portable device 10. In the present embodiment, when the user uses the key, the control unit 60 performs a process of presuming where the key is put away and reporting.

Each of the pocket modules 100a is a module provided on an opening portion of a pocket of the garment, and includes an electrode unit 110a, a transmission unit 112a, a control unit 114a and a memory 116a. In the present embodiment, the pocket module 100a can be freely detached and attached with a velcro tape (registered trademark), a button, and the like.

The electrode unit 110a includes a signal electrode and a ground electrode, and is electrodes for communicating with the portable device 120 via the user. The electrode unit 110a is provided at a position with which it is easy to touch a user's hand, in the pocket of the coat 94. Here, not only when the electrode unit 110a touches the user's hand, but also when the user wears the glove and when the electrode unit 110a touches a user's arm via a sleeve (i.e., when the electrode unit 110a is opposite to a user's body), the human body communication using the electrode unit 110a can be performed.

The transmission unit 112a is composed of an electric circuit which has a band pass filter, and the transmission unit 112a transmits data stored in the memory 116a to the portable device 10 via the electrode unit 110a and the human body.

The control unit 114a controls data transmission to the portable device 10. The memory 116a stores an individual number of the pocket module 100a, or the like. In the present embodiment, when the control unit 114a can perform the human body communication with the portable device 10 via the electrode unit 110a, the control unit 114a controls the transmission unit 112a and transmits the individual number stored in the memory 116a to the portable device 10.

The key module 100b is provided on a portion (i.e., a portion which the user's hand touches) of the key as illustrated in FIG. 1, and includes an electrode unit 110b, a transmission unit 112b, a control unit 114b and a memory 116b, as with the pocket module 100a. Since details of each unit are the same as those of each unit in the pocket module 100a mentioned above, a description thereof is omitted. Here, the memory 116b stores an individual number of the key module. That is, in the present embodiment, when the control unit 114b can perform the human body communication with the portable device 10 via the electrode unit 110b, the control unit 114b controls the transmission unit 112b and transmits the individual number stored in the memory 116b to the portable device 10. Here, the key module 100b may be mounted on (or embedded into) the key beforehand, or may be provided on an attachment member that can be attached to the key.

The bag module 100c is provided on a portion of the bag (i.e., a portion which the hand touches when the user puts the hand in the pocket of the bag), and includes an electrode unit 110c, a transmission unit 112c, a control unit 114c and a memory 116c, as with the pocket module 100a. Since details of each unit are the same as those of each unit in the pocket module 100a mentioned above, a description thereof is omitted. Here, the memory 116c stores an individual number of the bag module 100c. In the present embodiment, when the control unit 114c can perform the human body communication with the portable device 10 via the electrode unit 110c, the control unit 114c controls the transmission unit 112c and transmits the individual number stored in the memory 116c to the portable device 10.

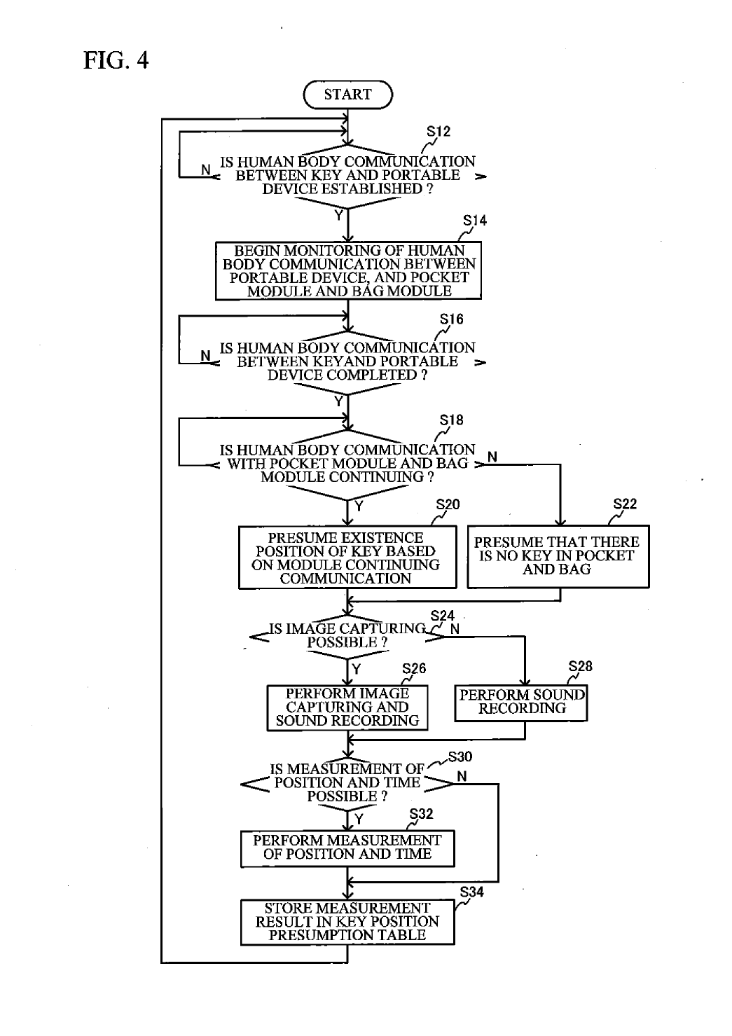

Next, a detailed description will be given of a collection process of information on an existence position of the key of the present embodiment according to a flowchart of FIG. 4 and with reference to the other drawings.

Here, the flowchart of FIG. 4 is begun in a state where a power supply of the portable device 10 is ON or the portable device 10 is the sleep mode (i.e., a state where operation by the user is not performed during a given time period and the supply of an electric power to an element having large power consumption is not performed).

In the process of FIG. 4, the control unit waits until the human body communication between a key 90 (i.e., the key module 100b) and the portable device 10 is established in step S12. In this case, the procedure advances to next step S14 in a stage where the human body communication between the key module 100b and the portable device 10 is established and the individual number of the key module 100b is transmitted from the transmission unit 112b of the key module 100b.

Advancing to step S14, the control unit 60 begins monitoring of the human body communication between the portable device 10, and the pocket module 100a and the bag module 100c. Here, when the control unit 60 performs the monitoring, the GPS module 21 may perform position measurement, the calendar unit 16 may detect the time, and the control unit 60 may store the results of the monitoring, the position measurement and the time detection into the flash memory 50.

Next, in step S16, the control unit 60 waits until the human body communication between a key 90 (i.e., the key module 100b) and the portable device 10 is completed. In this case, the procedure advances to next step S18 in a stage where transmitting the individual number of the key module 100b from the transmission unit 112b of the key module 100b to the control unit 60 is completed.

In step S18, when the human body communication between the key module 100b and the portable device 10 is completed, the control unit 60 judges whether the human body communication between the portable device 10, and the pocket module 100a and the bag module 100c is continuing. When the judgment of step S18 is positive, the procedure by the control unit 60 advances to step S20. When the judgment of step S18 is negative, the procedure advances to step S22.

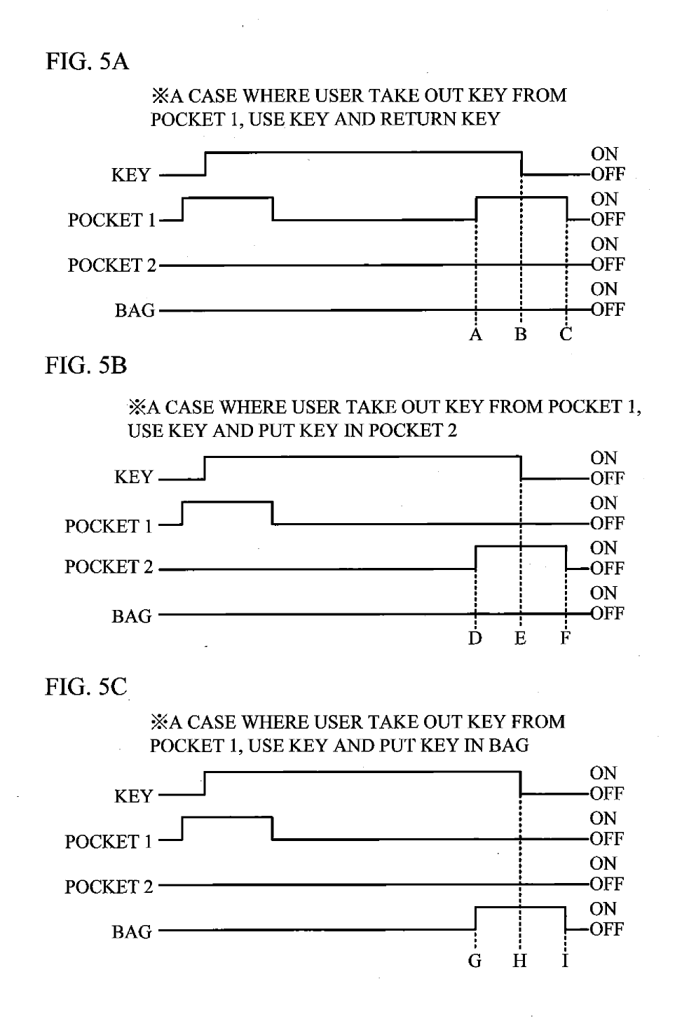

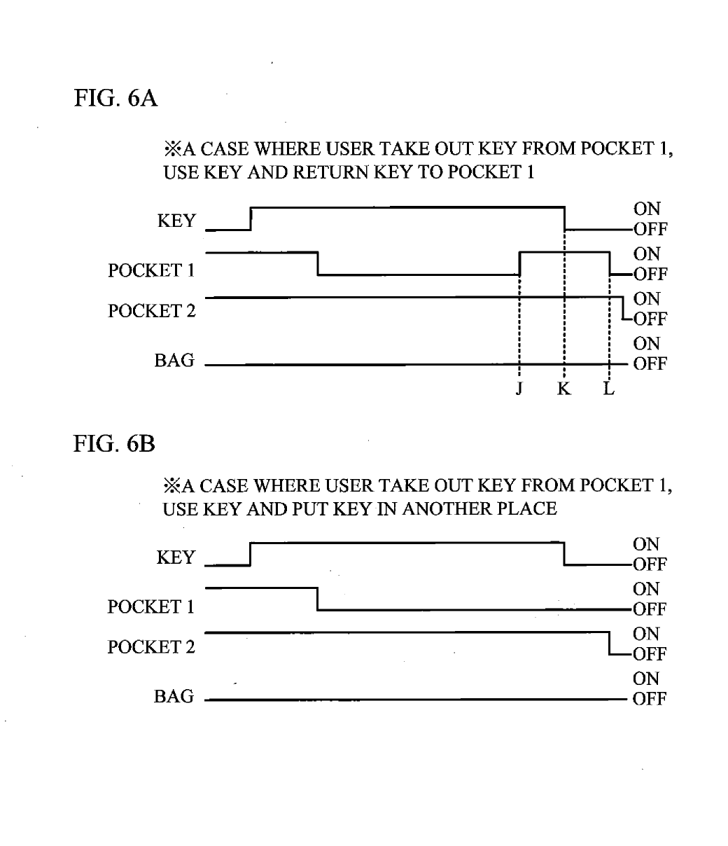

Here, a description will be given of relationships between a timing of human body communication between each module and the portable device 10, and the existence position of the key, based on FIGS. 5A to 6B.

FIG. 5A illustrates the transition of ON/OFF of the human body communication when the user takes out the key from one pocket (pocket 1) among the two pockets, uses the key, and then returns the key to the pocket 1. It can be read from FIG. 5A that the user puts the hand in the pocket 1 while touching the key (a timing A of FIG. 5A: a timing when the human body communication with the pocket 1 is established (ON)), the user releases the hand from the key while putting the hand in the pocket 1 (a timing B: a timing when the human body communication with the key is disconnected (OFF)), and then the user takes out the hand from the pocket 1 (a timing C: a timing when the human body communication with the pocket 1 is disconnected (OFF)).

FIG. 5B illustrates the transition of ON/OFF of the human body communication when the user takes out the key from one pocket (pocket 1) among the two pockets, uses the key, and then returns the key to a different pocket (pocket 2). It can be read from FIG. 5B that the user puts the hand in the pocket 2 while touching the key (a timing D of FIG. 5B: a timing when the human body communication with the pocket 2 is established (ON)), the user releases the hand from the key while putting the hand in the pocket 2 (a timing E: a timing when the human body communication with the key is disconnected (OFF)), and then the user takes out the hand from the pocket 2 (a timing F: a timing when the human body communication with the pocket 2 is disconnected (OFF)).

FIG. 5C illustrates the transition of ON/OFF of the human body communication when the user takes out the key from one pocket (the pocket 1) among the two pockets, uses the key, and then puts the key in the bag. It can be read from FIG. 5C that the user puts the hand in the bag while touching the key (a timing G of FIG. 5C: a timing when the human body communication with the bag 92 is established (ON)), the user releases the hand from the key while putting the hand in the bag (a timing H: a timing when the human body communication with the key is disconnected (OFF)), and then the user takes out the hand from the bag (a timing I: a timing when the human body communication with the bag 92 is disconnected (OFF)).

FIG. 6A illustrates the transition of ON/OFF of the human body communication when the user takes out the key from one pocket (the pocket 1) among the two pockets, uses the key, and then returns the key to the pocket 1. In case of FIG. 6A, it is unclear if the user puts one hand in the pocket 1 while touching the key by the hand (a timing J of FIG. 6A: a timing when the human body communication with the pocket 1 is established (ON)), the user releases the hand from the key in its state (a timing K: a timing when the human body communication with the key is disconnected (OFF)), and then the user takes out the hand from the pocket 1 (a timing L: a timing when the human body communication with the pocket 1 is disconnected (OFF)), or the user puts another hand in the pocket 2 and only touches the key put in the pocket 2 for a long time. However, also in this case, the control unit 60 can recognize that the key is included in either the pocket 1 or the pocket 2. Moreover, the control unit 60 obtains a log of the human body communication of the key 90, the pocket 1, the pocket 2 and the bag 92, and stores the log into the flash memory 50, so that the control unit 60 can recognize that the user has a habit of putting the hand in the pocket 2 or the user has a habit of usually putting a small article, such as the key, into the pocket 1. When the pocket in which the key puts differs from another pocket according to the garment, the control unit 60 can recognize (or predict) the action and the habit of the user by obtaining the above-mentioned log for each garment.

FIG. 6B illustrates the transition of ON/OFF of the human body communication when the user takes out the key from the pocket 1, uses the key, and then puts the key in a place different from the garment and the bag. In case of FIG. 6B, although the human body communication between the pocket 2 and the portable device 10 is performed when the human body communication between the key module 100b and the portable device 10 is completed, it is unclear if the user uses the key put in the pocket 1 by one hand and put the key at another place or the user only touches the key put in the pocket 2 for a long time by another hand put in the pocket 2. However, also in this case, the control unit 60 can recognize that there is a possibility that the key is included in the pocket 1 and there is no possibility that the key is included in the bag 92, and the control unit 60 can adequately presume the place of the key. Moreover, as described above, if the control unit 60 uses the log of the human body communication, the control unit 60 can obtain the action and the habit of the user, and hence the control unit 60 can presume the place of the key.

Here, the transitions of ON/OFF of the human body communication illustrated in FIGS. 5A to 6B are examples. That is, it is considered that various transitions of ON/OFF occur according to the number of modules for human body communication, or the like, but the control unit 60 can presume the place of the key and a place without the key.

Returning to FIG. 4, when the procedure advances to step S20, the control unit 60 presumes the existence position of the key according to the procedures as described above. Then, the procedure advances to step S24.

On the other hand, advancing to step S22, since the human body communication with the pocket module 100a and the bag module 100c is not performed when the human body communication with the key module 100b is completed, the control unit 60 presumes that there is no key in at least the pocket and the bag (the existence position of the key is unclear). Then, the procedure advances to step S24.

Advancing to step S24, the control unit 60 judges whether the image capturing unit 30 can capture an image of the garment of the user. In this case, the control unit 60 judges whether the user holds the portable device 10 based on the detection result of the biometric sensor 22 and the portable device 10 becomes an attitude as illustrated in FIG. 3 based on the detection result of the attitude sensor 23. When the judgment of step S24 is positive, the procedure advances to step S26, and the control unit 60 performs the image capturing by the image capturing unit 30 and the sound recording by the sound recording unit 32. In step S26, at a timing when the human body communication with the key is completed (i.e., timing when the user releases the hand from key), the garment of the user, and the sound and a voice around the user are monitored. The timing of the image capturing by the image capturing unit 30 may be performed suitably based on the detection result of the biometric sensor 22 and the detection result of the attitude sensor 23.

On the other hand, when the judgment of step S24 is negative, the procedure advances to step S28, and the control unit 60 performs only the sound recording by the sound recording unit 32 without performing the image capturing by image capturing unit 30. After the process of either step S26 or step S28, the procedure advances to step S30.

Advancing to step S30, the control unit 60 judges whether the position measurement by the GPS module 21 and the time detection by the calendar unit 16 are possible. When at least one of the judgments of step S30 is positive, the control unit 60 performs at least one of the position measurement using the GPS module 21 and the time detection by the calendar unit 16 in step S32, and then the procedure advances to step S34. On the other hand, when the judgment of step S30 is negative, the procedure advances to step S34 without passing step S32. Here, the control unit 60 may perform the processes of the image capturing and the sound recording and the processes of the position measurement and the time detection at the same time.

Advancing to step S34, the control unit 60 stores the obtained information into the key position presumption table. An example of the key position presumption table is illustrated by FIG. 7. As illustrated in FIG. 7, the key position presumption table includes respective fields of date and time, a presumed existence position of the key, a captured image, sound data, and position information. Date and time when the human body communication with the key module 100b is completed (e.g. the date and time can be obtained from the calendar unit 16) is inputted to the field of the date and time. A presumption result in step S20 or S22 is inputted to the field of the presumed existence position of the key. An image capturing result of step S26 (i.e., a file name of captured data) is inputted to the field of the captured image. A sound recording result of step S20 or S22 (i.e., a file name of sound data) is inputted to the field of the sound data. Point information (i.e., point information registered beforehand, such as a house, a school, an office, or the like) which can be led from the position information (e.g. the latitude and the longitude) measured in step S32 is inputted into the field of the position information.

When step S34 is completed as mentioned above, the procedure returns to step S12. And then, the process and the judgment of steps S12 to S34 are repeated (Information continues being accumulated in the key position presumption table of FIG. 7).

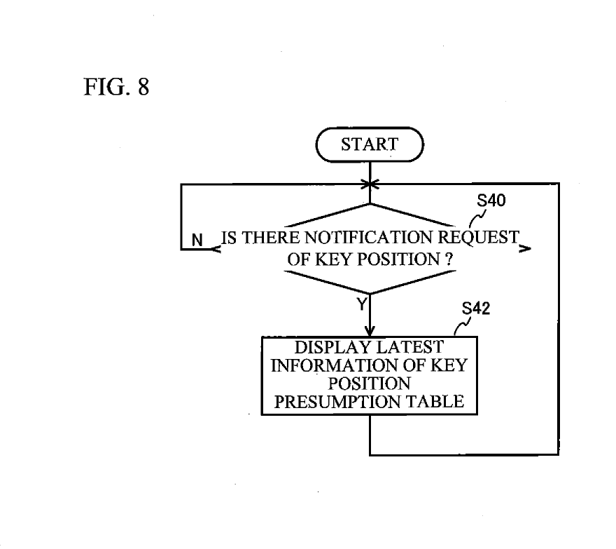

Next, a description will be given of a report process about the existence position of the key according to a flowchart of FIG. 8.

In the process of FIG. 8, the control unit 60 waits until a notification request of the key position is outputted by the user via the touch panel 14 in step S40. When the user outputs the notification request of the key position, the procedure advances to step S42 and the control unit 60 displays latest information on the display 12. Here, the notification request may be inputted by voice recognition or the like, for example. In this case, the user utters a word or a sentence, such as “key” or “where is the key ?”, to the microphone of the sound recording unit 32, so that the user can display the key position on the display 12.

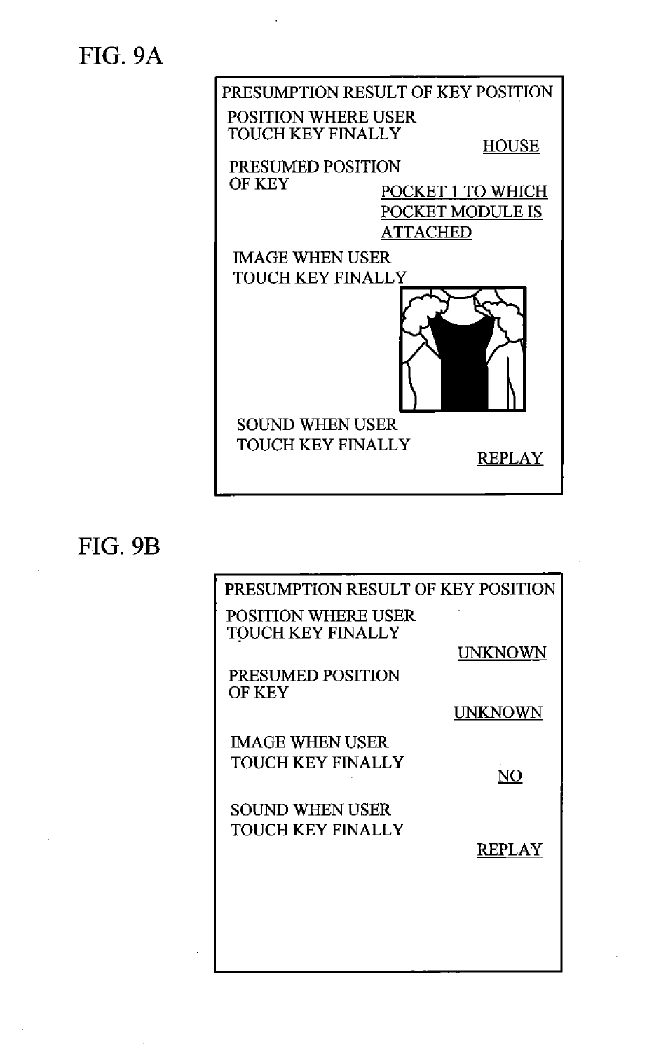

Here, information as illustrated in FIG. 9A or 9B is displayed on the display 12. When the image is displayed, the resizing unit 42 may resize (or perform trimming of) the garment detected by the garment detection unit 41, and the control unit 60 may display the resized garment on the display 12. The control unit 60 may display, on the display 12, an image of the garment before or after the user touches the key finally, instead of an image of FIG. 9A when the user touches the key finally. Moreover, even when the presumed existence position is unclear, there is no captured image, and the position information cannot be measured, either, there is a possibility that the user can remember a position where the user has placed the key, by the recorded sound, as illustrated in FIG. 9B. If sounds emitted right after the key is put (e.g. footsteps (sounds of slippers), a sound when the door is opened or closed, a sound when the user touches a thing other than the key, a voice of “I'm home”, conversation with a family, and so on) are recorded, the user can retrace memory from the sounds. When a position where the user has touched the key finally is unclear, the control unit 60 may display the output of the GPS module 21, and an area (e.g. an area between a house and a station) in which it is considered from the history of the human body communication that the user has touched the key finally, on the display 12 with the use of characters and a map. Here, in FIGS. 9A and 9B, information on time and date when the user has touched the key finally may be displayed.

In the present embodiment, although the description is given of a case where the information on the key is reported when there is the notification request from the user, as explained in FIG. 8, reporting the information on the key is not limited to this. For example, a module is provided beforehand inside the garment, and when the communication between the garment and the portable device 10 via the human body is completed (i.e., when the user takes off the garment), the information on the key may be displayed (reported) on the display 12. By doing so, the information on the key can be reported at a suitable timing. Moreover, when the human body communication between the garment and the portable device 10 is resumed (i.e., when a possibility that the user wears the garment and goes out is high), the information on the key may be reported. Here, the user may set the timing of reporting the information on the key, and a timing different from the above-mentioned timing may be adopted as the timing of reporting the information on the key.

As described above in detail, according to the present embodiment, when the user touches the electrode unit 110b provided on the key 90, the information on the key 90 (e.g. the individual number of the key module 100b, or the like) is inputted to the control unit 60 via the electrode unit 110b, the electrode unit 70 and the reception unit 18 (S12). When the user touches the electrode unit 110a or 110c in the state where the user holds the key 90, the information on the pocket or the bag (e.g. the individual number of the pocket module 100a or the bag module 100c, or the like) is inputted to the control unit 60 via the electrode unit 110a or 110c, the electrode unit 70 and the reception unit 18 (S14). Thereby, in the present embodiment, the control unit 60 can judge whether the hand holding the key is put into the pocket or the bag, and hence the control unit 60 can properly judge whether the existence position of the key is in the pocket or the bag. Thus, usability of the portable device 10 according to the present embodiment is improved from a viewpoint of easily finding the key. Here, when the key is attached to a key holder, a module for human body communication may be provided on the key holder.

Moreover, according to the present embodiment, since the control unit 60 detects the disconnection of the communication with the electrode unit 110b (S16), the control unit 60 can properly presume the key position based on a communication state with the pocket module 100a or the bag module 100c when the communication with the electrode unit 110b is disconnected.

Moreover, in the present embodiment, since the image capturing unit 30 captures a user's image at a timing when the user touches the electrode unit 110b of the key module 100b (S26), the user can properly presume the existence position of the key based on the state of the user (e.g. a worn garment) in the timing of touching the key, by viewing the captured image. In addition, since the GPS module 21 detects the position information when the image capturing unit 30 performs the image capturing (S32), the control unit 60 (or the user) can properly presume that the key exists in the house or outside the house (e.g. the office) based on the position information.

Moreover, in the present embodiment, since the sound recording unit 32 performs the sound recording at a timing when the user touches the electrode unit 110b of the key module 100b (S26, S28), the user can properly presume the existence position of the key by hearing the sound generated by the user or around the user in the timing of touching the key.

Moreover, in the present embodiment, since the pocket module 100a can be attached to or detached from the pocket, the pocket module 100a can be attached to the garment to be worn whenever the garment is worn. Thereby, compared with a case where the pocket module is fixed on (or sewn on) the garment, the number of pocket modules can be reduced, and hence the cost reduction can be realized. Since the pocket module can be detached in the case of cleaning of the garment, a waterproof performance required of the pocket module can be reduced. Also from this viewpoint, the cost reduction can be realized. However, the pocket module may be fixed on (or sewn on) the pocket. In this case, if information indicating that which pocket module is fixed on which pocket of which garment is stored in the memory 116a, a more detailed position of the key can be reported when the existence position of the key is reported to the user.

In the present embodiment, although the description is given of a case where the module for human body communication is provided on the pocket or the bag, the position at which the module is provided is not limited to this. The module for human body communication may be provided on an accessory case for storing the key at the house, a drawer, a closet, and so on, for example. By doing so, the control unit 60 can report the key position more exactly.

In the present embodiment, although the description is given of a case where the module for human body communication is provided on the key and the control unit 60 presumes the existence position of the key, the position at which the module is provided is not limited to this. The module for human body communication may be provided on an object, such as a wallet, an accessory, various cards such as credit cards, a lens cap of a single-lens reflex camera, important documents, and the like, for example. Moreover, the module for human body communication is provided on a handle of the bag, and the GPS module 21 obtains a position of the module in the case of the completion (disconnection) of the human body communication. Thereby, the control unit 60 can report to the user a place (a place which the user has forgotten) where the bag has been placed. In this case, the calendar unit 16 obtains a time in the case of the completion (disconnection) of the human body communication. Thereby, the control unit 60 can report to the user the time in which the bag has been forgotten.

In the present embodiment, although the description is given of a case where the image capturing unit 30 is provided in the portable device 10, the position at which the image capturing unit 30 is provided is not limited to this. The image capturing unit 30 may be provided on glasses, and may capture an image in the almost same range as a user's view at the timing when the human body communication with the key is terminated. In this case, the communication between the image capturing unit 30 and the portable device 10 may be proximity communication, or may be the human body communication. Moreover, the image capturing unit 30 may be provided on an object on which the user puts, such as a hat or a necklace, except for the glasses.

An object on which the user puts, such as a watch, glasses or a hearing aid, may have a function of the portable device 10 according to the above-mentioned embodiment.

In the present embodiment, although the description is given of a case where the human body communication between each module and the portable device 10 is performed, a communication method is not limited to this. The proximity communication may adopted as the communication between each module and the portable device 10.

The above-mentioned embodiment is a preferable embodiment of the present invention. However, the present invention is not limited to the above-mentioned embodiment, and other embodiments, variations and modifications may be made without departing from the scope of the present invention.

### DESCRIPTION OF REFERENCE NUMERALS

12 display
16 calendar unit
18 reception unit
21 GPS module
30 image capturing unit
32 sound recording unit
60 control unit
70 electrode unit
90 key
92 bag
94 coat
110a electrode unit
110c electrode unit
112a transmission unit
114a control unit

1. An electronic device comprising:
a communicator that is capable of performing short range communication or communication through a human body of a user;
a first inputter that, when the user touches a first object provided with a first communication member, inputs information on the first object via the first communication member and the communicator; and
a second inputter that, when the user touches a second object provided with a second communication member in a state where the user is holding the first object, inputs information on the second object via the second communication member and the communicator.

2. The electronic device according to claim 1, comprising:
a detector that detects that communication with the first communication member is disconnected.

3. The electronic device according to claim 2, comprising:
a presumption device that presumes a position of the first object, based on a detection result of the detector and the information which the second inputter inputs.

4. The electronic device according to claim 3, wherein
the second communication member is provided in a storage body capable of storing the first object, and
the presumption device presumes whether the first object is stored in the storage body.

5. The electronic device according to claim 1, wherein
the second object is an object that the user puts on, and
when the user puts on the second object, the second inputter inputs the information on the second object via the second communication member and the communicator.

6. The electronic device according to claim 1, comprising:
an image capturing device capable of capturing an image of the user.

7. The electronic device according to claim 6, wherein
the image capturing device captures the image of the user at a timing corresponding to touch to the first communication member by the user.

8. The electronic device according to claim 6, comprising:
a position sensor that detect position information when the image capturing device performs image capturing.

9. The electronic device according to claim 1, comprising:
a position sensor that detect position information when at least one of the first inputter and the second inputter inputs the information.

10. The electronic device according to claim 1, comprising:
a sound recorder that records a sound at a timing corresponding to touch to the first communication member by the user.

11. The electronic device according to claim 1, comprising:
a reporter that report a position of the first object to the user.

12. The electronic device according to claim 2, comprising:
an information obtainer that obtains information when the detector detects that communication with the first communication member is disconnected.

13. An electronic device comprising:
a first communicator that, when a user touches a first object provided with a first communication member, is capable of performing short range communication via the first communication member or human body communication through a human body of the user; and
an information obtainer that obtains information when communication with the first object by the first communicator is disconnected.

14. The electronic device according to claim 13, wherein
the information obtainer obtains at least one of information on a time and information on a place when the communication with the first object is disconnected.

15. The electronic device according to claim 13, comprising:
a second communicator that, when the user touches a second object provided with a second communication member, is capable of performing short range communication via the second communication member or human body communication through the human body of the user.

16. The electronic device according to claim 15, comprising:
a judger that, when communication with the second communication member by the second communicator is established, judges whether communication with the first communication member by the first communicator is established.

17. The electronic device according to claim 16, comprising:
a presumption device that presumes a position of the first object, based on a judgment result of the judger.

18. A garment comprising:
a communicator that is provided in the pocket and is capable of performing short range communication or human body communication through a human body of a user; and
an outputter that outputs information on the pocket via the communicator.

19. The garment according to claim 18, wherein
the outputter outputs information indicating that a part of the human body touches the pocket.

20. The garment according to claim 18, wherein
the outputter outputs information on a position of the pocket.

21. The garment according to claim 18, wherein
the communicator is attachable to or detachable from the pocket.

22. An electronic device comprising:
a communicator capable of communicating with a first communication member provided on a first object, and a second communication member provided on a second object capable of storing the first object; and
a judger that judges whether the first object is stored in the second object, based on a communication result of the communicator.

23. The electronic device according to claim 22, wherein
when communication between the first communication member and the communicator is disconnected, the judger judges that the first object is released from a hand of the user.
